(19) United States
(12) Patent Application Publication
(10) Pub. No.: US 2007/0206705 A1
(43) Pub. Date: Sep. 6, 2007

(54) RFID reader with adjustable filtering and adaptive backscatter processing

(75) Inventor: Roger Green Stewart, Morgan Hill, CA (US)

Correspondence Address: Zilka-Kotab, PC, P.O. BOX 721120, SAN JOSE, CA, 95172-1120, US

(73) Assignee: APPLIED WIRELESS IDENTIFICATION GROUP, INC.

(21) Appl. No.: 11/367,061

(22) Filed: Mar. 3, 2006

(51) Int. Cl. H04L 27/00; H04Q 5/22; G06F 3/033; G08B 13/14

(52) U.S. Cl. 375/316; 340/10.1; 340/572.4; 455/130

(57) ABSTRACT

A Radio Frequency Identification (RFID) reader in one embodiment of the invention includes an amplifier for amplifying an incoming RF signal, a switchable filter receiving an amplified signal from the amplifier, and mixers receiving a filtered signal from the filter. An RFID reader in another embodiment of the invention includes an RF section with an RF signal level control. A baseband section with baseband signal level control receives a signal from the RF section. The RF signal level control and the baseband signal level control are dynamically adjustable independently of each other. An RFID reader in another embodiment of the invention includes RF signal level control, and mixers receiving a signal from the RF signal level control. A level of a signal between the RF signal level control and the mixers is monitored. The RF signal level control is adjusted based on the monitored signal for preventing saturation of the mixers. Methods are also presented.

### FIELD OF THE INVENTION

The present invention relates to Radio Frequency Identification (RFID) readers, and more particularly, this invention relates to a new RFID reader architecture.

### BACKGROUND OF THE INVENTION

RFID technology employs a radio frequency (“RF”) wireless link and ultra-small embedded computer circuitry on an RFID tag. RFID technology allows physical objects to be identified and tracked via these wireless “tags”. It functions like a bar code that communicates to the reader automatically, but without requiring manual line-of-sight scanning or singulation of the objects. RFID promises to radically transform the retail, pharmaceutical, military, transportation, and other industries.

In the automatic data identification industry, the use of RFID transponders (also known as RFID tags) has grown in prominence as a way to track data regarding an object to which the RFID transponder is affixed. An RFID transponder generally includes a semiconductor memory in which digital information may be stored, such as an electrically erasable, programmable read-only memory (EEPROMs) or similar electronic memory device. Under a technique referred to as “backscatter modulation,” the RFID transponders transmit stored data by reflecting varying amounts of an electromagnetic field provided by an RFID interrogator by modifying their antenna matching impedances. The RFID transponders can therefore operate independently of the frequency of the energizing field, and as a result, the interrogator may operate at multiple frequencies so as to avoid radio frequency (RF) interference, such as utilizing frequency hopping spread spectrum modulation techniques. The RFID transponders may either extract their power from the electromagnetic field provided by the interrogator, or may include their own power source.

Since RFID transponders do not include a radio transceiver, they can be manufactured in very small, light weight and inexpensive units. RFID transponders that extract their power from the interrogating electromagnetic field are particularly cost effective since they lack a power source. In view of these advantages, RFID transponders can be used in many types of applications in which it is desirable to track information regarding a moving or inaccessible object.

The backscatter-modulated signal reflected by the RFID transponder may contain relatively low power and dynamic range. Therefore, it is important for the RFID interrogator to minimize the noise in both the transmitted and received signal paths in order to achieve an acceptable read range and error rate of the received data. The RFID interrogator transmits full power to the tag while receiving data, in accordance with the backscatter modulation technique. As a result of the simultaneous carrier transmision and receive function, a portion of the transmitted signal can leak into the received signal path, providing a significant source of noise to the received signal. Moreover, there may only be a small frequency offset between the transmitting and receiving signal frequencies, further producing noise and interference with the received signal. The mixing stage can produce signal components that reflect back into the carrier, or that can produce absolute and/or additive phase noise.

Additionally, the shape of the outgoing waveform has a great impact on the backscatter-modulated signal. Current RFID interrogators create an outgoing signal in an on/off manner. This creates a waveform with steep edges. However, steep-edged waveforms have been found to create a noisy backscatter-modulated signal.

Accordingly, it would be very desirable to provide an RFID reader having a receiver/transmitter architecture that attenuates these and other inherent noise sources in order to achieve increased read range and reduced error rate of the received data.

### SUMMARY OF THE INVENTION

A Radio Frequency Identification (RFID) reader according to one embodiment of the present invention includes an amplifier for amplifying an incoming RF signal, a switchable filter receiving an amplified signal from the amplifier, the filtering characteristics of the filter being selectable, and mixers receiving a filtered signal from the filter.

An RFID reader according to another embodiment of the present invention includes an RF section further comprising an RF signal level control. A baseband section receives a signal from the RF section, the baseband section further comprising baseband signal level control. The RF signal level control and the baseband signal level control are dynamically adjustable independently of each other.

An RFID reader according to yet another embodiment of the present invention includes RF signal level control, and mixers receiving a signal from the RF signal level control. A level of a signal between the RF signal level control and the mixers is monitored, and the RF signal level control is adjusted based on the monitored signal for preventing saturation of the mixers.

A method for processing an RF signal according to one embodiment of the present invention includes converting an RF signal to a baseband signal, amplifying the baseband signal, filtering the baseband signal, monitoring the amplified and filtered signal, and adjusting characteristics of a filter based on the monitoring.

A method for processing an RF signal according to another embodiment of the present invention includes converting an RF signal to a baseband signal, amplifying the baseband signal, filtering the baseband signal using a filter, and adjusting characteristics of the filter based on parameters of a communications protocol.

A method for processing a Radio Frequency (RF) signal according to yet another embodiment of the present invention includes setting an RF gain stage to an initial condition, setting a baseband gain stage to an initial condition, monitoring a signal having passed through both gain stages, and adjusting one of the gain stages based on the monitoring

An RFID reader according to yet another embodiment of the present invention includes an analog amplifier for amplifying an incoming RF signal, a switched capacitance filter, and a digital signal processor (DSP).

An RFID reader according to yet another embodiment of the present invention includes an RF signal level monitoring mechanism, and a baseband signal level monitoring mechanism.

An RFID reader according to yet another embodiment of the present invention includes a switched capacitance filter having different settings during a listen before talk mode than during a tag reading mode.

A method according to yet another embodiment of the present invention includes turning off a transmitter, setting filtering parameters of a switched capacitance filter, and monitoring a power level of an incoming signal.

A method according to yet another embodiment of the present invention includes adjusting a listen before talk threshold power level as a function of time.

An RFID system includes a plurality of RFID tags and an RFID reader in communication with the RFID tags. Each tag may be coupled to an object, each tag storing information about the object to which coupled. Likewise, each tag may have a unique identifier, the identifier being correlated with information about the object in a database.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of an RFID system according to one embodiment of the present invention.

FIG. 2 is a system diagram of an RFID reader according to one embodiment of the present invention.

FIG. 3 is a circuit diagram of an amplitude modulator according to one embodiment.

FIG. 4 is a flow diagram of an illustrative process for generating a digitally synthesized waveform.

FIG. 5 is a flow diagram of a process for setting up a reader according to an illustrative embodiment.

FIG. 6 is a flow diagram of a process performed during reader operation according to an illustrative embodiment.

### BEST MODE FOR CARRYING OUT THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

The use of RFID tags are quickly gaining popularity for use in the monitoring and tracking of an item. RFID technology allows a user to remotely store and retrieve data in connection with an item utilizing a small, unobtrusive tag. As an RFID tag operates in the radio frequency (RF) portion of the electromagnetic spectrum, an electromagnetic or electrostatic coupling can occur between an RFID tag affixed to an item and an RFID tag reader. This coupling is advantageous, as it precludes the need for a direct contact or line of sight connection between the tag and the reader.

Utilizing an RFID tag, an item may be tagged at a period when the initial properties of the item are known. For example, this first tagging of the item may correspond with the beginning of the manufacturing process, or may occur as an item is first packaged for delivery. Electronically tagging the item allows for subsequent electronic exchanges of information between the tagged item and a user, wherein a user may read information stored within the tag and may additionally write information to the tag.

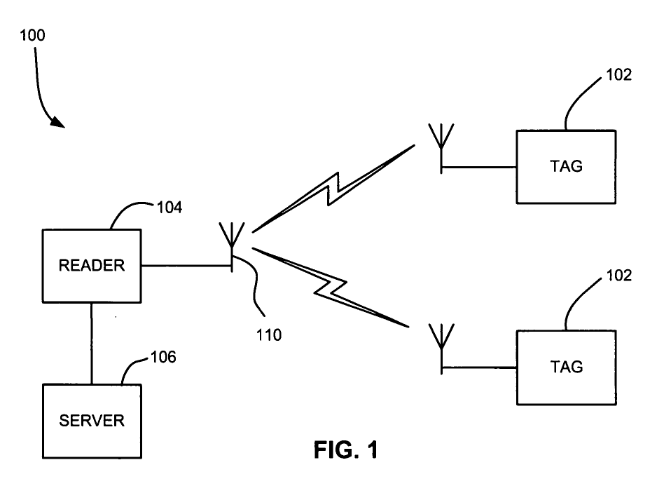

As shown in FIG. 1, an RFID system 100 typically includes RFID tags 102, an interrogator or “reader” 104, and an optional server 106 or other backend “client” system which may include databases containing information relating to RFID tags and/or tagged items. Each tag 102 may be coupled to an object. Each tag 102 includes a chip and an antenna. The chip includes a digital decoder needed to execute the computer commands that the tag 102 receives from the reader 104. The chip may also include a power supply circuit to extract and regulate power from the RF reader; a detector to decode signals from the reader; a backscatter modulator, a transmitter to send data back to the reader; anti-collision protocol circuits; and at least enough memory to store its unique identification code, e.g., Electronic Product Code (EPC).

The EPC is a simple, compact identifier that uniquely identifies objects (items, cases, pallets, locations, etc.) in the supply chain. The EPC is built around a basic hierarchical idea that can be used to express a wide variety of different, existing numbering systems, like the EAN.UCC System Keys, UID, VIN, and other numbering systems. Like many current numbering schemes used in commerce, the EPC is divided into numbers that identify the manufacturer and product type. In addition, the EPC uses an extra set of digits, a serial number, to identify unique items. A typical EPC number contains:
1. Header, which identifies the length, type, structure, version and generation of EPC;
2. Manager Number, which identifies the company or company entity;
3. Object Class, similar to a stock keeping unit or SKU; and
4. Serial Number, which is the specific instance of the Object Class being tagged.
   Additional fields may also be used as part of the EPC in order to properly encode and decode information from different numbering systems into their native (human-readable) forms.

Each tag 102 may also store information about the item to which coupled, including but not limited to a name or type of item, serial number of the item, date of manufacture, place of manufacture, owner identification, origin and/or destination information, expiration date, composition, information relating to or assigned by governmental agencies and regulations, etc. Furthermore, data relating to an item can be stored in one or more databases linked to the RFID tag. These databases do not reside on the tag, but rather are linked to the tag through a unique identifier(s) or reference key(s).

Communication begins with a reader 104 sending out signals via radio wave to find a tag 102. When the radio wave hits the tag 102 and the tag 102 recognizes and responds to the reader's signal, the reader 104 decodes the data programmed into the tag 102. The information is then passed to a server 106 for processing, storage, and/or propagation to another computing device. By tagging a variety of items, information about the nature and location of goods can be known instantly and automatically.

Many RFID systems use reflected or “backscattered” radio frequency (RF) waves to transmit information from the tag 102 to the reader 104. Since passive (Class-1 and Class-2) tags get all of their power from the reader signal, the tags are only powered when in the beam of the reader 104.

The Auto ID Center EPC-Compliant tag classes are set forth below:

Class-1

Identity tags (RF user programmable, range ˜3 m)

Lowest cost

Class-2

Memory tags (8 bits to 128 Mbits programmable at ˜3 m range)

Security & privacy protection

Low cost

Class-3

Semi-passive tags (also called semi-active tags)

Battery tags (256 bits to 64 Kb)

Self-Powered Backscatter (internal clock, sensor interface support)

˜100 meter range

Moderate cost

Class-4

Active tags

Active transmission (permits tag-speaks-first operating modes)

˜30,000 meter range

Higher cost

In RFID systems where passive receivers (i.e., Class-1 and Class-2 tags) are able to capture enough energy from the transmitted RF to power the device, no batteries are necessary. In systems where distance prevents powering a device in this manner, an alternative power source must be used. For these “alternate” systems (also known as active or semi-passive), batteries are the most common form of power. This greatly increases read range, and the reliability of tag reads, because the tag does not need power from the reader to respond. Class-3 tags only need a 10 mV signal from the reader in comparison to the 500 mV that a Class-1 tag needs to operate. This 2,500:1 reduction in power requirement permits Class-3 tags to operate out to a distance of 100 meters or more compared with a Class-1 range of only about 3 meters. Note that semi-passive and active tags may also operate in passive mode, using only energy captured from an incoming RF signal to operate and respond.

Active, semi-passive and passive RFID tags may operate within various regions of the radio frequency spectrum. Lower frequency (30 KHz to 500 KHz) tags have low system costs and are limited to short reading ranges. Lower frequency tags may be used in security access and animal identification applications for example. Ultra-High-Frequency (850 MHz to 950 MHz and 2.4 GHz to 2.5 GHz) tags offer increased read ranges and high reading speeds. One illustrative application of Ultra-High Frequency tags is automated toll collection on highways and interstates.

It should be kept in mind that the present invention can be implemented using any type of tag, and the readers described herein are presented as only a few possible implementations.

Reader Illustrative Embodiment

To provide a context in which to aid in the understanding of the invention, an illustrative RFID reader will now be described. It should be kept in mind that the specificity with which some components and their operation are described is not meant to limit the broad concepts of the invention, but rather to disclose one of the many possible implementations thereof.

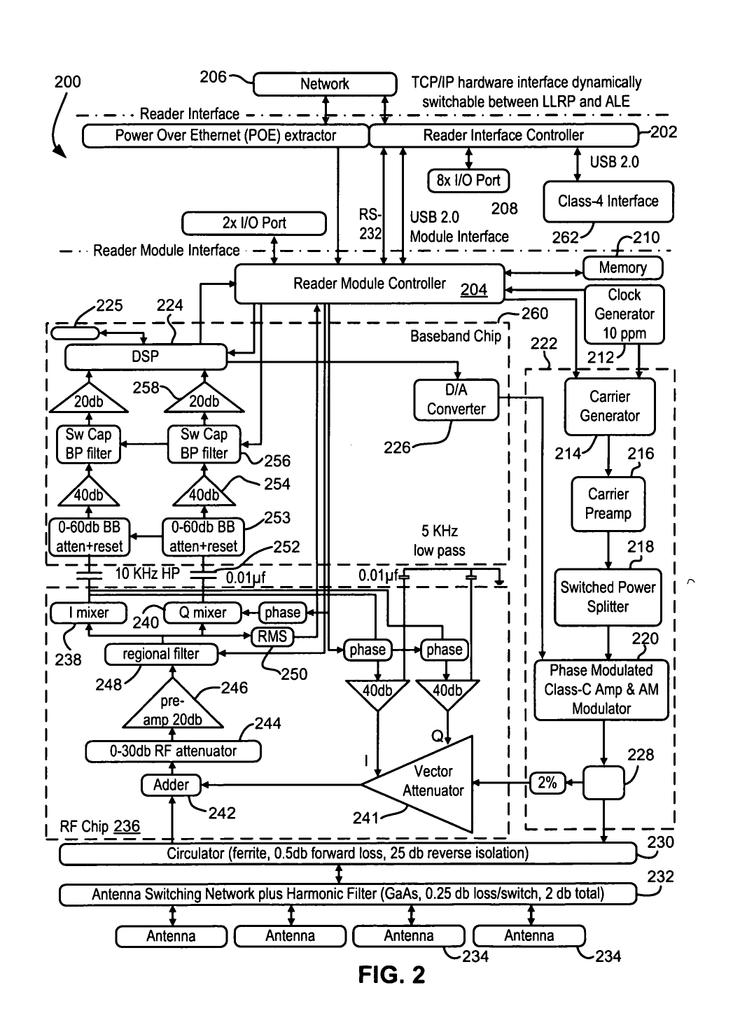

FIG. 2 is a system diagram of an RFID interrogator or “reader” 200 according to one embodiment of the present invention.

Hardware flexibility may be provided by separating the reader 200 into two hardware sections: an interface section and a separate reader module section. The interface section provides connectivity to the outside world, aside from RF communication with RFID tags. The reader module section is responsible for communicating with the RFID tags.

The reader 200 shown in FIG. 2 includes three microprocessors with work responsibilities divided as follows: A “packet processor” 224 compiles symbol waveforms into transmitted packets of data and then decodes packets of data that are backscattered back to the reader from the tags. The “module controller” 204 stores and executes the required protocols and controls all of the gain, power, and bandwidth settings of the reader 200. The “interface controller” 202 provides a user-friendly interface to the network(s) and to all of the middleware systems. The functions of some or all of these processors/controllers can be combined into a single chip, or divided out further into discrete processors.

With continued reference to FIG. 2, an interface controller 202 may be included with the reader 200 to provide network access, to manage interrupts, to implement Smart Reader functions such as Listen-Before-Talk, and to implement a number of interface protocols between the reader 200 and the client and other devices. As shown, the interface controller 202 is in communication with the reader module controller 204 and a network 206, e.g., local area network and/or a wide area network. The interface controller 202 may also provide connectivity for peripheral equipment via I/O ports 208, e.g., USB ports, etc. The interface controller 202 may be any microprocessor, such as an ARM-9 chip running at a 180 MHz clock rate, an 8051 processor, etc. The interface controller 202 in one illustrative embodiment operates on a Windows platform; uses a TCP/IP hardware interface to the network(s); supports LLRP with about 12 Mbps data rates and about 100 μs over the local interface; and can also operate autonomously via its application-level events (ALE) interface.

The module controller 204 stores and executes all of the internal functions of the reader 200 including managing the packet processor 224, local interrupts, the RF circuitry, the anti-collision protocols, the local tag search and scouring algorithms, and the interference rejection algorithms. In an illustrative embodiment, the module controller 204 communicates down to the packet processor 224 at roughly a 1 KHz packet rate. Likewise, the module controller 204 communicates upward with one or more client systems, e.g., reader server(s), and the network(s) via a TCP/IP hardware interface and LLRP and/or ALE software interfaces. The module controller 204 may support USB data rates of 12 Mbps or higher with a latency of about 100 μs. The module controller 204 may be any microprocessor, such as an ARM-9 chip running at a about 180 MHz clock rate, an 8051 processor, etc. In alternate embodiments, the interface controller 202 and module controller 204 are integrated into the same chip.

Memory 210 is present. The memory 210 may include random access memory (RAM), read only memory (ROM), and other types of writeable and/or read only, volatile and/or nonvolatile memory.

A clock generator 212 provides the reference clock signal used by the system during data encoding and decoding. The clock generator 212 preferably has at least a 10 ppm accuracy.

A carrier generator 214 generates the carrier signal for outgoing RF transmissions. The module controller 204 controls the channel frequency of the carrier generator 214 directly via its I/O ports and the 10 ppm clock generator within the range 865-956MHz. The carrier generator 214 in an illustrative embodiment allows frequency hopping within the 865-956 MHz range, 1 mW output, minimum phase noise, and preferably less than −110 dbc/Hz at 100 KHz offset, may switch and stabilize at a new frequency within 1 ms, and has a 10 ppm accuracy. The single oscillator non-“ping-pong”-design of this illustrative embodiment requires the amplifier/modulator to be turned off during the 1 ms time the carrier generator 214 will need to hop and stabilize at each new frequency. Note that other embodiments may implement a dual oscillator “ping-pong” design.

A carrier preamplifier 216 amplifies the carrier signal generated by the carrier generator 214. The carrier preamplifer preferably generates about a >+5 dbm output, e.g., about +7 dbm. After pre-amplification, a power splitter 218 directs some of the un-modulated carrier signal back to drive the receiver mixers. The remaining carrier signal is directed to the amplifier/modulator 220. In a preferred embodiment, the switchable power splitter 218 sends about +4 dbm to the mixers 238, 240, and also switches between sending either about +4 dbm or as little as about −30 dbm to the amplifier/modulator 220 depending on whether the module controller 204 has switched the transmitter on or off.

The amplifier/modulator 220 is the main phase-modulated amplifier where the output power level may be amplified to, for example, about +34 dbm or about 2.3 Watts. This ˜4 db margin insures that a full 1 W or more is available at each antenna in spite of the un-avoidable losses associated with the circulator, GaAs antenna switching network, and cable losses.

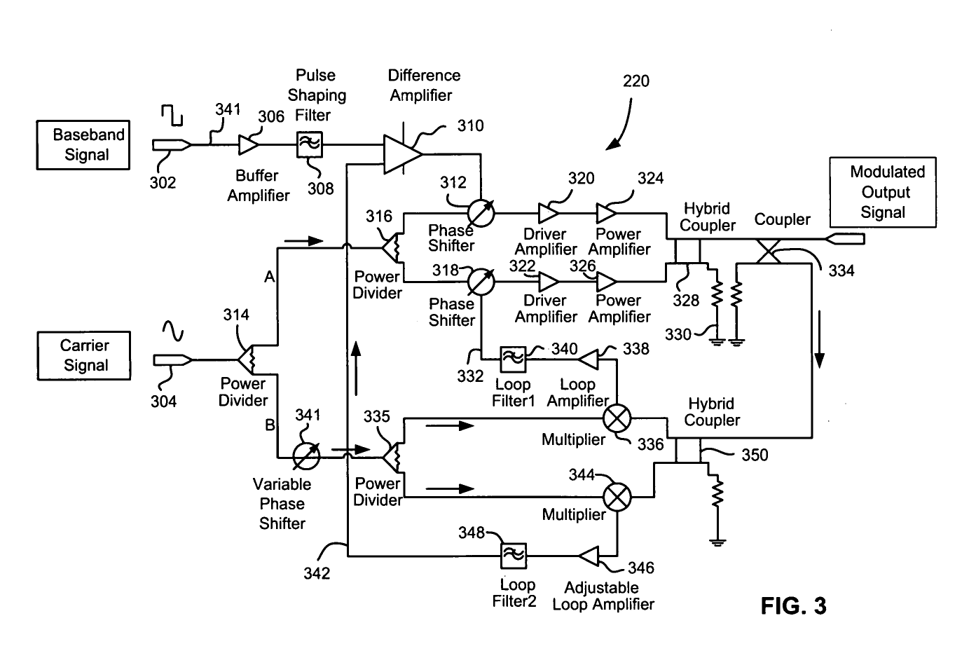

One illustrative phase-modulated amplifier 220 is disclosed copending U.S. patent application Ser. No. 11/207,348to Zhou et al., filed Aug. 19, 2005and which is herein incorporated by reference. FIG. 3 illustrates a phase-modulated amplifier 220 according to one embodiment of the present invention. In brief, a baseband signal is introduced at input 302 and an RF carrier signal is introduced at input 304. The carrier signal is split by a conventional power divider 314 into paths A and B. Following path A, the carrier signal is again divided into two paths by a second power divider 316 and then passed to a first phase shifter 312 and a second phase shifter 318. The phase shifters change the phase of the signals going into power amplifiers 324, 326 and optional driver amplifiers 320, 322.

The gain of the power amplifiers 324, 326 is controlled by individual control signals to ensure no excessive energy is wasted. Each power amplifier 324, 326 also receives a phase modulated input signal that is at a constant envelope, which allows the designer to use energy efficient nonlinear amplifiers without introducing excessive noise. If the signal input to the power amplifier were not constant (as in the case where the input signals were already modulated), then the amplifier would be dynamically adjusting its bias condition based on the input signal amplitude, with the result that the amplified signal would occupy a very wide frequency band (if nonlinear amplifiers are used). The wider frequency band includes more interference to the nearby radio frequency operated equipment.

Amplitude modulation is achieved by combining the two amplified and phase modulated signals using a first combiner 328, which in the exemplary embodiment shown is a hybrid coupler. One exemplary combiner for doing both AM modulation and phase reversal-amplitude shift keyed (PR-ASK) is a 3 dB 180° coupler.

When the amplified signals from the phase shifters 312,318 are combined, the combined signal will vary from optimum when the phases are aligned, to a point where the signals might cancel portions of each other out when the phases are misaligned by 180degrees. In an ideal situation, the phases of the two signals are shifted in the opposite direction on a phase plane, equal in variation of angles. The in-phase sum of the two signals becomes the desired output, while the quadature sum becomes unwanted and goes into a dump 330 at the first combiner 328. If the two phase shifters did not provide the same amount of phase shift, a residual phase shift may potentially then be created with the output signal.

The total power output of the AM modulated output signal can be precisely controlled by adjusting the amplifiers 320, 322, 324, 326 and/or buffer amplifier 308, so the spectrum of the AM modulated output signal can be made very sharp, in other words, made to occupy a very small spectrum. This enables, for example, RFID devices to function in a dense reader environment, where each reader may use a different spectrum for communications with tags. This also allows RFID devices to operate in jurisdictions where regulations only allow communications in a small bandwidth. An additional benefit of being able to use nonlinear amplifiers with adjustable gain to control the level of the AM modulated signal output is that energy is conserved. Note that if energy conservation is not a concern, linear amplifiers could be used.

Further, by allowing precise control of the amplitude and phase of the modulated signal, the pulse can be shaped to occupy a very narrow frequency band. An additional benefit is that by using two power amplifiers, each amplifier provides a constant power for each signal branch.

The portion of the circuit described above is able to perform the modulation, but is not perfect. Accordingly, additional components may be provided to further enhance the signal.

To lock the phase of the AM modulated output to the carrier signal, a first feedback loop 332 acts as a phase lock loop by extracting a portion of the AM modulated output signal at coupler 334, combining it with the carrier input signal, and directing that back to the second phase shifter 318. This has the effect of locking the AM modulated signal to the carrier input signal, thereby eliminating any residual phase variation (phase noise) in the AM modulated output signal. Accordingly, the phase change is used to create an AM modulated output which has virtually no phase noise.

The carrier signal is the reference signal for the first feedback loop 332. As shown, the carrier signal follows path B and is split into two paths by a power divider 335. A mixer/multiplier 336 combines the extracted AM modulated signal with the carrier input signal. The carrier signal is compared to the AM modulated output to see if there is any phase difference between the two. Upon mixing the signals, a baseband signal is generated, which has a lower frequency compared to the carrier signal, but a similar or slightly higher frequency range than the AM modulated output. In other words, the frequency of the baseband signal is less than the frequency of the carrier signal, the carrier signal sometimes being referred to as the local oscillator signal. The baseband signal sets the modulator frequency.

There is something critical about the phase shift. The AM output signal at best will have no residual phase shift. Ideally, its phase would follow the phase of a sine wave. If the phase loosens up during modulation, it will occupy a larger bandwidth. Essentially, the multiplier 336 acts as a phase detector that identifies the difference between the AM modulated output and the reference signal (carrier).

The output signal from the mixer/multiplier 336 continues on the first feedback loop 332, where a loop amplifier 338 amplifies the signal, and a low pass filter 340 removes high frequency noise from the signal and stabilize the loop. The amplified and filtered signal is applied to the second phase shifter 318, thereby controlling operation of the second phase shifter 318.

Accordingly, the first feedback loop 332 automatically controls the second phase shifter 318, with the result that the modulated signal at the output will have about the same phase as the input RF carrier signal. Thus, residual phase shift is essentially removed. A variable delay line/phase shifter 341 is placed on Path B before power divider 335 to ensure the stability of the system for a broad RF operating frequency band.

Referring now to the baseband signal input line 341 and the second feedback loop 342, it is seen that the baseband signal affects the first phase shifter 312, changing the phase of the signals passing through the first phase shifter 312 by up to 180 degrees. The baseband signal is coupled through a conventional buffer amplifier 306. A conventional pulse (spectrum) shaping filter 308 provides a shaped input signal to a difference amplifier 310. The difference amplifier 310, in turn generates a control signal for controlling the first phase shifter 312.

In order to have a narrow AM output spectrum, an RF carrier signal is preferably modulated with a frequency limited baseband signal. However, a digital signal like the baseband signal occupies a large frequency band. This signal needs to be shaped. Merely placing a filter on the baseband input line will not significantly limit the bandwidth of the baseband signal. Rather, some linearization is preferred.

A problem solved by the embodiment shown is that the amplitude of the carrier signal does not otherwise follow linearly to the phase shifter control voltage. The non-linearity comes from two aspects. One is from the control voltage-phase shift relationship of a reflective phase shifter, and the other is from the trigonometric combining of two RF signals. Assume a 1V phase shifter control signal applied to the first phase shifter creates a 10% shift. A 2V control input results in a 15% shift, and so on. This nonlinearity must be compensated for to obtain a clean AM output signal. The second feedback loop 342 corrects the amplitude response to the phase shifter control voltage. In other words, the phase shifter control voltage is made linearly proportional to the amplitude of the AM modulated output signal.

Referring now to operation of the second feedback loop 342, the carrier signal follows path B, where a mixer/multiplier 344 combines the extracted AM modulated signal with the carrier input signal. This mixer/multiplier also acts as the RF amplitude detector. The combined signal continues on the second feedback loop 342, where an adjustable loop amplifier 346 amplifies the signal, and a low pass filter 348 filters the signal. The functions of the amplifier 346 and filter 348 are similar to those of the filter 340 and amplifier 338 of the first feedback loop 332. The amplifier 346 is this case makes the feedback signal stronger so it becomes comparable to the baseband control signal. Usually the baseband control signal is a 0 or 1 digitally, indicated by high and low signals or by length of high signal, length of low signal, etc. Typical high and low voltages are 1 V and 4V, 0.5 V and 3V, etc. The adjustable nature of the amplifier 346 allows the feedback signal (amplitude detector output) to be in about the same range as the baseband signal at the difference amplifier 310.

The amplified and filtered signal is directed to the difference amplifier 310, which may be an operation amplifier. The difference amplifier 310 develops a control signal by comparison of the shaped baseband signal and the envelope of the AM modulated output signal (amplitude detector signal) from the second feedback loop 342. Any difference becomes the error signal output of the difference amplifier 310, which is used to control the first phase shifter 312.

The second feedback loop 342 acts as a linearization loop that directs some of the AM modulated output back to the difference amplifier 310 at the baseband signal input line 341. This feedback scheme makes the envelope amplitude of the AM modulated output signal linearly proportional to the amplitude of the baseband input signal by compensating for the non-linearity of the phase shifter response and phase modulation to amplitude modulation conversion. The second feedback loop 342 may be either analog or digital.

In a preferred embodiment, the phase of the first feedback loop 332 is locked, and the second feedback loop 342 has a 180degree phase shift from the first feedback loop 332. The power divider 335, multipliers 336 and 344, and hybrid coupler 350 form a quadature downconverter. All variations of quadature downconverters may be used here to detect the amplitude and phase of the modulated output.

One skilled in the art will appreciate that some or all of the power dividers, combiners, couplers, multipliers, etc. shown can be replaced by circuitry providing equivalent functionality, and so the present invention is not to be limited to the embodiment shown in FIG. 3. For instance, rather than detecting the envelope of the AM modulated output signal using the mixer/multiplier 344, a diode or rectifier can be used. In another variation, any form of power combiner, including transformer, hybrid coupler, in-phase combiner and out-of-phase combiner, can be used to replace the power divider 316, power divider 335, hybrid coupler 328 and/or hybrid coupler 350.

There has thus been described a circuit that performs well as an amplitude modulator. The inputs to the power amplifiers are at a constant amplitude, allowing use of energy efficient nonlinear amplifiers.

Additionally, there is no residual output phase drifting compared to the carrier signal due to the presence and effect of the first feedback loop 332.

The second feedback loop 342 ensures that the amplitude of the AM output signal is linearly proportional to the baseband signal voltage. This in turn allows use of a simple filter in the baseband signal input line to define the spectrum.

Referring again to FIG. 2, the carrier generator 214, carrier preamplifier 216, switched power splitter, and amplifier/modulator 220 may be embodied on a single RF transmitter chip 222.

A packet processor 224 assembles and decodes command packets as directed by the module controller 204. The module controller 204 controls the packet processor 224 by first sending instructions for building a command packet along with key packet parameters which are then stored in the packet processor 224. The module controller 204 then sends the data payload for each packet that it wants the packet processor 224 to generate, after which the packet processor 224 generates and sends out the packet before requesting parameters for a new packet from the module controller 204. In a preferred embodiment, the packet processor 224 will only send out or decode one packet at a time, and except for the “instructions and packet parameters” described above, may not store or know anything about the algorithms being executed.

Likewise, the module controller 204 may also command the packet processor 224 to decode packets using instructions and packet parameters that it will send to the packet processor 224. In response, the packet processor 224 will send the packet data contents and cyclical redundancy check (CRC) parameters back up to the module controller 204 so that the module controller 204 can check the CRC to verify whether or not the contents are correct. Again, in a preferred embodiment, the packet processor 224 preferably only decodes one packet at a time, does not store or know anything about the algorithms being executed, and does not try to determine whether or not the data it receives is accurate. This makes the packet processor 224 very efficient. However, some of these functions may be performed by the packet processor 224.

In a “software radio” design, both the digital content and all of the parameters (data frequency (rate), symbol type or format, harmonic content, modulation type, modulation depth, power interrupt time, etc.) may all be controlled by the modulation waveforms stored in the packet processor memory 225 or calculated by the packet processor 224. Not only can the reader 200 be easily programmed to support all existing C1G1, C1G2, ISO 1800 waveforms, USA optimized waveforms, Japanese waveforms, Europe waveforms, Phase Reversal-Amplitude Shift Keying (PR-ASK) waveforms, etc., but this digital synthesis design can be subsequently and remotely programmed over the network 206 to create modulation waveforms yet to be conceived. The shape and content is limited only by what will fit into the maximum regulatory channel allocation, e.g., currently 500 KHz for FCC in the United States.

The packet processor 224 may be any type of processor, such as those described above, and in preferred embodiments comprises a digital signal processor (DSP) for high performance. A packet processor 224 according to another embodiment is a broadband 10 KHz to 300 KHz processor with about an 8 MHz data sampling interval.

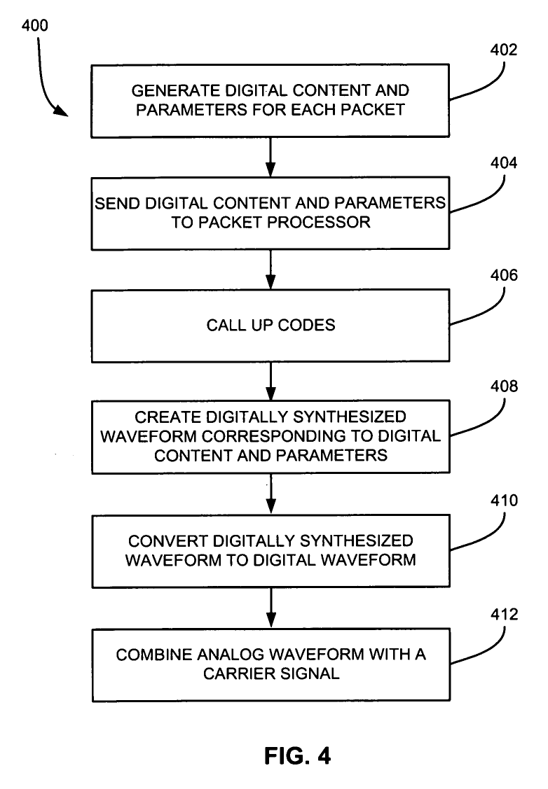

During a send process 400, represented in FIG. 4, the packet processor 224 generates a digitally synthesized baseband waveform that represents data. More particularly, when amplitude modulating the carrier, the packet processor 224, e.g., DSP, is used to digitally synthesize the exact shape of the amplitude modulation waveform. In this “signal transmission” mode, in operation 402, the module controller 204 first generates the digital content of each outgoing information packet one at a time to the packet processor 224 along with the modulation rate, modulation depth, and other analog parameters for that particular packet. In operation 404, the digital content and parameters are sent to the packet processor 224. In operation 406, the packet processor 224 calls up a sequence of, e.g., 12-bit codes from memory 225 or 210 at a high, e.g., 8 MHz sampling rate appropriate to the individual characters in the packet and the analog parameters selected by the module controller 204 for that packet. The packet processor 224 then creates the digitally synthesized waveform from the codes retrieved from memory in operation 408. Each code may be a series of samples, or sampling points, that represent a particular symbol, i.e., 0, 1, or special character in the packet. The samples indicate, bit by bit, what level to output. Thus, the packet processor can create any arbitrary shape of the waveform. A series of samples may in turn comprise a packet that is sent to the D/A converter 226 for conversion to an analog waveform in operation 410 and ultimately combination with a carrier signal in operation 412.

Alternatively, each code may provide parameters from which the packet processor 224 can calculate the samples that make up the digitally synthesized waveform. For example, several samples for a particular symbol can be represented in the code. The packet processor 224 then calculates the additional samples to complete the waveforn.

In further embodiments, the packet processor 224 calculates the samples on the fly. For example, the packet processor 224 can algorithmically use a prior data point and a target sample to calculate a current sample. Further, the packet processor 224 may calculate the samples based entirely or in part on parameters received from the module controller 204.

In still other embodiments, the packets may include phase modulated as well as amplitude modulated waveforms. PR-ASK may be achieved by extending the phase range of the two phase shifters in the phase modulated amplifier 220 so that the phase relationship of the two amplifiers can be set to greater than a 180° offset. One skilled in the art will appreciate how the phase modulated amplifier 220 of FIG. 3 can be so modified. For example, the phase relationship between the two amplifiers may be continually raised from, for example, about 0-20° (in phase) maximum output; to (out of phase) minimum output at 180°; to 340-360° (in phase) maximum amplitude. Phase reversal enables up to twice the data rate for a given spectrum of occupancy over a <180° offset-capable embodiment. When supporting PR-ASK modulation, the phase shift of the hybrid coupler 328 is increased to about 180°. Also, the operating range of the phase shifters 312, 318 are also increased from 90° to about 180°.

The packet processor 224 may also apply a scaling factor to the samples to adjust such things as amplitude, timing between peaks or high and low points, etc. For example, a scaling factor of, say, 0.8can be applied to reduce the amplitude to 80% thereof, e.g., for reducing interference. The samples can be calculated or retrieved as set forth above prior to application of the scaling factor. Scaling of the maximum amplitude can also be used as a form of output power level control.

If the modulation depth being used is creating interference, the modulation depth may be reduced by loading different waveforms.

In summary, the packet processor 224 can form the symbols and component parts either statically (preloaded in memory), dynamically (computed on the fly), or a combination of the two.

In pure digital, the high point in the waveform is a 1, while the low point is a 0. The packet processor 224 calculates a series of samples (data values) in between 0 and 1, or retrieves a sample map from memory, or combination thereof The number of points in between the high and low may be selected based on physical characteristics of the signal, sampling rates, transmission rates, etc., and can be calculated in the packet processor 224. Some embodiments may use a linear formula, a step formula, etc. to calculate the number of samples. Other embodiments use a preset number of points.

The packet processor 224 can generate waveforms of varying character. For instance, the waveform may have a 95% modulation depth with a deliberate 5% overshoot to steepen the rising and falling waveforms as much as possible within the FCC and international regulatory limits. Compliance with EPC global C1G2 Dense Reader Transmit Mask channel specifications is preferably achieved with the packet processor 224. The packet processor 224 may also use feedback from the output of a power amplifier, e.g., Class-C amplifier, to help cancel out power amplifier waveform distortion. The packet processor 224 preferably has at least about 10 ppm accuracy.

Similarly, the attack and delay of the waveform edges, i.e., slope of the edges, can be individually adjusted to reduce interference. Typically, the sharper the edges of an outgoing waveform, the more spurious interference that is generated. Strict on/off produces very sharp edges, resulting in spurious signal. Ideally, the edges generated by the packet processor 224 have a slope that is not completely vertical.

Because the packet processor 224 has such precise control over the waveform shape, each individual symbol in the digitally synthesized waveform can be tuned to the particular reader for such things as minimizing occurrence of a spurious signal in the resultant outgoing analog waveform. At least some of the particular samples used to generate the digitally synthesized waveform may be selected based on an outgoing signal generating characteristic of the reader. For example, a correction factor can be applied to the calculated or stored samples used to create the digitally synthesized waveform.

The rates of rise or fall of the edges being controllable provides an additional benefit. The slope is not necessarily a linear progression up or down, but rather can be selected to negate effects in the modulator itself. For example, if the designer or reader 200 notice that a certain effect occurs at a transition, the packet processor 224 can generate points that average out the transition to negate the effect. Alternatively, the packet processor 224 can retrieve a transition symbol from memory that compensates for the effect. Thus, samples that appear to be randomly selected may in actuality average out to a nearly-ideal point. Because there is an analog component, the resulting waveform appears smooth.

Accordingly, not only can the occurrence of spurious noise be reduced, but the signal can also be tuned to the particular reader.

The digitally synthesized baseband signal is converted to an analog signal in a digital to analog (D/A) converter 226. The analog baseband signal is then added to the carrier signal at the amplifier/modulator 220. The D/A converter 226 in one embodiment is capable of performing about 8 million conversions/sec. in forward (transmit) mode. Accuracy may be modified and filtering may be included as necessary to meet regulatory specifications, e.g., EPC global specifications for Dense Reader Operation.

The amplifier/modulator 220 amplifies, phase modulates, and combines the carrier signal with the analog version of the synthesized waveform to generate an outgoing signal. In one embodiment, the amplifier/modulator 220 is a phase modulated class-C amplifier with about a +34 dbm output in the range 865-956 MHz. The amplifier/modulator 220 in the illustrative embodiment has a 30 db gain when on, and about <−30 db gain when switched off by the module controller 204.

A fixed power splitter 228 splits the outgoing signal. A portion of the signal, e.g., about 2% of the signal, is used for carrier cancellation, which will be described in more detail below. The majority of the signal, e.g., about 98%, is directed to a ferrite circulator 230, an antenna switching network 232 (if more than one antenna), and finally to the antenna(s) 234.

In an illustrative embodiment, the circulator 230 has a maximum 0.5 db forward and reverse loss, and a minimum of about 25 db reverse isolation. The antenna switching network 232 in the illustrative embodiment includes a discrete network of GaAs switches. Each switch has an insertion loss of about 0.25 db at 900 MHz, and the network has a total loss of about 2 db including roughly 1 db loss through the harmonic filter. The network 232 may also generate some additional harmonic frequencies that can be filtered out at each antenna port using a harmonic filter comprised of a RC passive network with 1 db loss and filtering as necessary to meet regulatory requirements.

The antenna(s) 234 may be dual transmit/receive antenna(s), or individual antennas can be provided for each function. In an illustrative embodiment, each antenna 234 has about a 6 db gain. Some harmonic filtering may also be included with each antenna. The reader 200 in the illustrative embodiment is designed to deliver about 31.5 db to each antenna output port, to allow the reader to compensate for up to about 1.5 db of coax cable losses between the reader and the physical antenna and still output the full 4 W EIRP signal allowed under FCC regulations. Depending on the type of cable selected, the full 4 W EIRP output can be maintained with cable lengths of about 10 to about 20 feet.

The RF receiver 236 includes adaptive carrier cancellation circuitry to provide, for example up to 30 db, suppression of the reader's own carrier frequency. This is accomplished by subtracting a replica portion of the outgoing carrier signal (including its associated AM modulation and/or phase noise) from the received signal at the input to the RF receiver section 236. The phase and amplitude of the subtracted replica are optimized using negative feedback from low-pass filtered outputs from the I and Q mixers 238, 240 and a vector attenuator 241.

The I and Q outputs of the mixers are parts of two analog negative feedback control loops that separately adjust the amount of their respective I and Q components of the transmitted carrier signal in order to minimize the total RF energy present at the I and/or Q mixers. This indirectly corrects for both phase and Doppler-frequency differences between the outgoing and incoming carrier frequencies.

The outputs from the mixers 238, 240 going into the analog carrier cancellation feedback loops are low-pass filtered, e.g., at about 5 KHz, to improve loop stability and suppress spurious signals in the carrier cancellation control loops. The low pass filters take the feedback signals down to direct current (DC). The feedback signals control the I and Q components of the outgoing signal being fed back to the incoming signal. Preferably, the feedback signals run into separate I and a Q attenuators, which create I and Q cancellation signals. The resultant cancellation signal is fed into the adder 242 where it is added to the incoming signal, thereby cancelling carrier leakage and its associated phase noise, antenna to antenna coupling, environment-reflected noise, etc.

Unlike the limited carrier suppression provided by “bi-static” antennas, the adaptive carrier cancellation circuit is both cheaper, more effective, and compensates for a wider range of the unwanted carrier reflection problems. Specifically the adaptive carrier cancellation circuit provides, in addition to the e.g., about 25 db, carrier suppression provided by the circulator, an additional e.g., about 30 db, suppression (about 55 db total) for:
Carrier leakage within the reader,
Carrier reflections from the antenna,
Carrier reflections from reflective objects in the field,
Up to e.g., 30 db suppression of the phase noise and modulation artifacts associated with the carrier.

The adaptive carrier cancellation circuitry also suppresses unwanted Doppler-shifted reflections caused either by moving objects in the field or by movement of the reader 200 itself. In other words, even if the reader 200 is moving or a reflective object in the environment is moving, and even if the frequencies don't match, the I and Q levels will naturally adapt to cancel out the varying signal. In an illustrative embodiment with about a 5 KHz frequency limit on the feedback control loops, the adaptive carrier cancellation circuit will provide up to about 30 db suppression of the reflected carrier even with movement velocities of 15 MPH, and up to about 16 db suppression even at 75 MPH.

The adaptive carrier cancellation circuitry is preferably run for a few cycles in order to reach a steady state. Carrier cancellation may be performed even when the reader 200 is modulating the outgoing signal. Thus, the preliminary cycling can be performed while the reader 200 is transmitting so that the RF receiver section 236 is optimized and ready to receive the incoming signal.

As noted above, an analog RF adder 242 is part of the adaptive carrier cancellation circuit. The adder 242 subtracts a replica of the reader's output (including the associated phase noise) from the receiver input signal thereby reducing the adder output signal to less than about −10 db under most conditions. However during system start up, or when operating in highly RF-reflective environments, or with “hot tags” near the reader 200, the adder output can increase to more than about −10 db and these unusual conditions may be handled by attenuating the adder signal in an RF attenuator 244 before it is presented to the RF preamplifier 246.

In an illustrative embodiment, the RF attenuator 244 is controlled by the module controller 204 in about 6 db increments in the range of about 0 db to about 30 db. Attenuator response and settling times may be less than 10 μ. The RF attenuator 244 may be bypassed entirely with GaAs switches if necessary to reduce attenuation losses to less than about 0.5 db.

The RF preamplifier 246 may provide a constant gain. In such an embodiment, the RF attenuator 244 is used by the module controller 204 to control saturation of the mixers. Alternatively, the RF preamplifier 246 may act under the control of the module controller 204 to adjust the RF level going into the mixers 238, 240 to prevent mixer saturation.

In an illustrative embodiment, the RF preamplifier 246 is an AC coupled differential RF preamplifier with about 20 db gain and about a 4 db noise figure; the overall receiver noise figure at the antenna is about 8 db. These preamplifier specifications are compatible with detecting tag backscatter at levels as low as about −105 db with about 10 db S/N ratio using DSP with frequency filtering to about 2 KHz. The output saturation level for this amplifier 246 may be at least 6 db higher than the saturation level of the mixers, which includes about 3 db power for the power splitter, about 2 db for the regional band filter 248, plus about 1 db margin.

Various fixed frequency band filters present in a single switchable regional filter 248 may be added to optimize performance in particular regions. For example, frequency ranges are 902-928 MHz in USA, 868-870MHz in Europe, 950-956 MHz in Japan, etc. The regional filter 248 may be eliminated or bypassed if necessary to permit the same reader 200 to operate in multiple regions with different operating bands of frequencies.

The location of the regional filter 248 is important, as the filter may be lossy, i.e., has attenuation. Accordingly, rather than place the regional filter 248 out in front of the RF receiver 236, which degrades the noise figure of the device, the regional filter 248 is positioned within or after the preamplifier 246 (gain stage). This placement is advantageous because more attenuation is acceptable after the gain stage as the attenuation no longer degrades the noise figure of the reader 200. Note however, that some embodiments may place the regional filter 248 in front of the preamplifier.

In an illustrative embodiment of the regional filter 248, in-band insertion losses do not exceed about 2 db. In preferred embodiments, Surface Acoustic Wave (SAW) filters are used with out-of-band roll-off that are as steep as possible but preferably not less than about 6 db at 10 MHz from band edge. The regional filter 248 operates under the control of the module controller 204, or may be switched manually at manufacturing.

To avoid saturation of the I and Q mixers, a root mean square (RMS) or peak-to-peak signal detector 250 detects signals higher than a preset value, e.g., 10 dbm, at both of the mixer inputs and alerts the module controller 204 to increase or decrease the attenuation setting of the RF attenuator 244 and/or the gain from the RF preamplifier 246 if adjustable (collectively or individually functioning as RF signal level control) to keep the RF signal level at the input to both mixers 238, 240 below the mixer saturation levels.

Thus, the reader 200 has an analog control loop (carrier cancellation loop) and a separate digital loop from the level detector 250 to the module controller 204 and back to the attenuator 244. In the embodiment shown, the digital loop senses the RMS level, and when the module controller 204 observes it dropping, reduces the attenuation to increase gain at the front end. So as the noise and spurious carrier signals are reduced, as the circuit adapts to cancel noise levels, and other noise subsides (e.g., noise from another reader), then the reader may automatically increase gain to make the reader more sensitive. The reader 200 shown is believed to achieve about an 8 dB noise figure, where typical designs are at about 20 dB and higher

In an illustrative embodiment, each mixer is an 860-960 MHz mixer with less than about 3 db loss, and a lowest noise figure of preferably less than about 15 db, a highest possible saturation level of at least about 0 dbm but up to about 30 dbm is preferred.

The signals from the mixers 238, 240 are ultimately decoded by a processor and sent to the module controller 204 for further processing. In the embodiment shown, the processor receiving the mixer signals is the packet processor 224. Note that, as shown, the packet processor 224 functions during both encoding and decoding of data. Other embodiments of the present invention include discrete packet processors 224 for encoding and decoding signals. Yet other embodiments include a packet processor 224 responsible for the in-phase (I) portion of the incoming and/or outgoing signal and another packet processor 224 responsible for the quadrature (Q) portion of the incoming and/or outgoing signal. In further embodiments, the module controller 204 performs some or all of these encoding/decoding functions.

Since unwanted interference from other readers and noise sources is often a more severe problem in practical operating systems than thermal noise, etc., the reader 200 in a preferred embodiment includes an adaptive backscatter processing section having adaptable filtering and gain. To that end, a preferred embodiment of the present invention includes four levels of interference filtering to optimize interference rejection: a regional filter 248 (introduced above), channel filtering, sub-channel filtering, and DSP filtering. Further, baseband signal level control includes several attenuators and/or amplifiers which may be independently adjustable to not only optimize the baseband signal but also to prevent saturation of the packet processor.

While precise filtering is hard to do on the RF signal itself, including a first level of coarse regional filtering is important to prevent saturation of the mixers 238, 240 and RF preamplifier by the out-of-band interference from TV stations, etc. The three switchable high-Q dielectric bandpass filters used in the preferred embodiment provide 10 db or more suppression of this out-of-band interference for any signal more than 20 MHz from the edge of the regional band. The regional filter 248 is automatically adjusted by the module controller 204 to optimize its performance for the “region” in which that reader is operating: Europe (865-868 MHz), USA/Korea (902-926 MHz), and Japan (950-956 MHz). Alternatively, in a lower cost solution, the reader can be adapted to a regional band by interchanging the proper SAW filter into a standardized board socket.

Next, low-pass and high-pass channel filters may be integrated into preamplifiers 254 immediately after the mixers to further improve interference rejection. The 10 KHz high-pass filter 252 takes out both the residual carrier signal, most Doppler-shifted carrier reflections, and most of the phase noise close to the carrier. The low-pass “channel” filtering may be adjustable in steps, e.g., about 100 KHz, about 250 KHz, and about 1000 KHz, each selectable depending on the bandwidth of the backscatter that the reader 200 expects to get back from the tag. By preventing un-needed high-frequency signals from ever getting through the preamplifiers 254, the channel filters help prevent saturation of the preamplifier 254 by strong signals in adjacent channels. The channel filters also provide an excellent second stage of interference rejection for out-of-band noise sources such as TV stations, etc.

The output from the mixers going into the analog carrier cancellation feedback circuit is also low-pass filtered, e.g., at about 5 KHz, to improve loop stability and suppress spurious signals in the carrier cancellation control loop. A 5 KHz bandwidth in the control loop is sufficient to provide 30 db cancellation even for Doppler shifted carrier reflections for objects traveling at up to about 15 mph, and 16 db suppression of Doppler-shifted reflections from objects traveling at about 75 mph.

The third stage of interference rejection filtering is provided by an analog sub-channel switched capacitance filter 256. While the switched capacitance filter 256 provides much better bandpass filtering than either the regional or channel filter, the switched capacitance filter 256 may have an effective noise figure of about 40 db and so may be much noisier than either the mixers or the preamplifiers. Degradation of the reader's noise figure is avoided by providing just enough gain in the RF preamplifiers 246 and baseband preamplifiers 254 to prevent the switched capacitance filter 256 from significantly degrading the reader's e.g., about 8 db noise figure.

The switched capacitance filter 256 sub-channel filter preferably passes only those frequency components that will actually be used by the DSP 224. The switched capacitance filter 256 bandpass filtering in a preferred embodiment may be bypassed and is software controllable in the range of about 10-100 KHz, is accurate to about 2 KHz, and uses a 4th-order or higher Butterworth or Bessell filtering and switchable “zeros” to provide at least about 30 db rejection at one octave above or below its passband. This zero helps suppress the carrier signals that might be coming from adjacent channels at, e.g., 500 KHz (US) and 200 KHz (Europe). The switched capacitance filter 256 passband parameters are initially set by the module controller 204 based on the nominal backscatter parameters, but subsequently may be reset and tightened in real time on a tag-by-tag basis based on the measured backscatter characteristics for that particular tag.

The switched capacitance filter 256 sub-channel filter provides additional protection against saturation of the baseband amplifiers and/or the packet processor 224, e.g., DSP. The switched capacitance filter 256 also dramatically reduces the DSP work load and significantly improves the DSP decoding success rate by improving the signal to noise (S/N) ratio at the DSP input e.g., by up to about 20 db.

Further interference filtering is also performed in the DSP 224 itself. The DSP 224 may use the preamble to extract a ±1% estimate for the actual packet frequency backscattered to it by the tag. This frequency is then used to help decode the packet data contents that follow the preamble. If necessary, this extracted backscatter frequency data may also be used to re-adjust and tighten the DSP filtering parameters to improve the S/N ratios of the backscatter signal sent to the DSP 224.

Although the DSP 224 provides precise and flexible filtering, its associated quantization noise makes the DSP much noisier than even the switched capacitance filter 256. When decoding narrow-band signals, even a 12-bit A/D converter has an effective noise figure of about 65 db. Degradation of the reader's noise figure is avoided by providing just enough gain in the preceding amplifiers to prevent the DSP 224 from significantly degrading the reader's e.g., about 8 db noise figure.

In some embodiments, the signal frequency at the output of the baseband amplifiers is also measured and this information is used to adjust a frequency filter upstream in the baseband pipeline so as to allow only that frequency to pass through the baseband amplifiers to the output. This further reduces the unwanted noise and interference signals.

In summary, the operating parameters for the four filtering levels may all be controlled by the module controller 204 in real time and if necessary can be separately optimized for each tag being read. This adaptive filtering control provides the maximum possible rejection for all known types of interference. The adaptive filtering also allows the module controller 204 to gradually increase the gain of the various amplifiers without saturating the circuit as the effectiveness of the filters increases. The RF level at the input to the mixer is preferably measured and adjusted with the variable gain RF preamplifier 246 to “standardize the level” to an optimum value, e.g., of approximately 0 dbm. Similarly, the baseband output levels may also be measured and standardized to an optimum value, e.g., of approximately 0.5V.

In addition, the amplifier gain provided between each stage of interference filtering may also be adaptively controlled by the module controller 204 in real time. Each amplifier is also designed for the maximum practical dynamic range consistent with its fabrication technology. Under typical conditions, each amplifier operates at nominal gain thereby allowing the reader 200 to operate with maximum sensitivity based on its nominal (e.g., about 8 db) noise figure design. However if confronted with an extremely noisy, hostile or badly managed reader environment, the reader 200 will automatically detect the problem and may automatically reduce the amplifier gain in one or more of the amplifier stages as necessary to prevent saturation. Even in these hostile conditions, the reader 200 may always operate with as much gain as possible and thereby provide the best noise figure possible under this condition.

Illustrative circuitry for providing the multi-level filtering includes a baseband attenuator 253. The baseband attenuator hay have an attenuator response and settling times of less than about 10 μs; and about a 640 kbps FMO bandwidth at roughly 1000 KHz. The RF attenuators 253 are controlled by the module controller 204 in 6 db increments in the range of about 0 db to about 60 db, and preferably have an attenuator response and settling times of less than about 10 μs with about a 640 kbps bandwidth. The baseband attenuators 253 may each include a channel filter that is adjusted by the module controller 204 for optimal operation in the USA, Europe, etc.

The baseband preamplifiers 254 may each include an AC coupled differential RF preamplifier having about a 40 db gain and about a 4 db noise figure. The overall receiver noise figure at the antenna is about 8 db. The minimum saturation input level is about 100 mV RMS in/1V RMS out—about 2.8V peak-to-peak consistent with a power supply voltage of about 3.3V. The preamplifiers 254 use a precharge circuit to recover from a maximum about 500 mV input saturation (that may occur during modulated transmission) to better than about 6 μV sensitivity in less than about 14 μs. Bandwidth as necessary to pass about 640 kbps FMO signals—roughly 1 MHz, 4-pole or more Butterworth/Chebyechef or Bessell filtering with at least about 30 db/octave rolloff.

The switched capacitor bandpass filter 256 may have a 10 ppm accuracy, software controlled precision switched capacitor filter, bandpass width controlled in the range 10 KHz to 100 KHz bandwidth (5-40 kbps), and a maximum noise level of 100 μV per √Hz. The switched capacitor sub-channel filter may also achieve 60 db suppression of the adjacent channel.

The baseband amplifiers 258 may have about a 20 db gain, min 3V peak-to-peak output saturation level, and may use a precharge circuit to recover from a maximum 500 mV input saturation (that may occur during modulated transmission) to better than 100 μs sensitivity in less than 10 μs. The bandwidth is about 1 MHz as necessary to pass FMO modulated signals at 640 Kbps The DSP 224 may be one or more 12-bit digital signal processors. The resolution of the DSP may be higher, e.g., 16 bit, or lower, e.g., 6 to 8 bits. A lower resolution DSP would permit the simplified DSP to be more cost-effectively integrated into a low-power baseband receiver chip 260 thereby further reducing both the cost and power dissipation of the reader 200.

Optional hardware modules may also be coupled to the reader 200. For example, a class-4 sub-reader 262 permits the reader 200 to retrieve EPC global ID numbers and other information from fully active tags operating spread spectrum at about 6.4 GHz.

Firmware/Software

The reader may have a “software radio” type design with general-purpose flexible hardware. The reader may be adapted to a wide range of different applications, may support many current and future protocols, and may operate in multiple international regulatory environments by changing only the firmware/software that is loaded into the interface controller, the module controller, and the DSP microcomputer modules. This firmware can be downloaded or modified remotely over the network.

In an illustrative embodiment, the DSP and associated 12-bit A/D converter(s) operate at about 4 million samples/sec/channel as necessary to conduct over-sampling on a backscatter signal with harmonics of up to about 1MHz. The DSP firmware extracts from the signal both the data and spectral frequency of the data. As alluded to above, it may also be able to separate out and ignore energy at other frequencies that are not part of the tag backscatter signal that we are trying to detect and decode. The firmware may also be able to learn to recognize and then ignore other repetitive noise sources. The DSP firmware may also be able to estimate backscatter signal strength and report this to the module controller.

The DSP firmware may also be responsive to the setup parameters that it receives from the module controller including setting the range of its frequency response, what kind of data encoding to look for (e.g., FM0, Miller, FSK, etc.), and to look for and subtract out known noise sources such as the carrier, carrier phase noise, fluorescent lamps, fans, etc.

The module controller software may include such things as reader management software, interrupt management, and tag protocols. Network coordination software and middleware may also be provided.

When it includes a reader interface controller, the reader can preferably support multiple software interfaces. When operating alone or in an un-crowded environment, the reader may operate autonomously as a “smart reader” by exposing its EPC Global-compliant ALE interface and interfacing directly with various application programs above it. In this “smart reader” mode, the reader minimizes interference with other readers and other devices by implementing an advanced “Listen-Before-Talk” algorithm.

When the reader is operating in a dense reader environment, the best system performance is achieved by operating thorough its LLRP interface instead of the ALE interface. By exposing its EPC Global-compliant LLRP interface, the reader can now send additional important information out to an external Client including:

Anti-collision information about the frequency of collided slots, singular slots, empty slots,

Protocol status including Q value, and operating session number,

Real-time information about the types and classes of tags found—C1G1, C3G2, non-standard EPC numbers, directory info, etc.

Real-time requests for tag-specific information like KILL passwords, encryption decoding, WRITE data, etc.

Current reader parametric values including modulation rates, attenuation settings, filter settings, regulatory parameters.

When operating in the LLRP interface mode, the reader may then also respond quickly to additional commands from the Client including:
Commands to increase, reduce, or terminate transmission power,
Issue unconditional or conditional commands to immediately hop frequency,
Change forward or backscatter modulation rates,
Change Q values, switch operating Sessions, or change Select fields,
Change tag scouring algorithms on the fly,
Switch antennas,
WRITE, KILL, or LOCK tags quickly in real time either unconditionally or conditionally based on the EPC code or data read out from that specific tag.

In its ALE mode, the reader may also support an advanced version of Listen-Before-Talk (“LBT”) needed for both European Regulatory compliance and for autonomous operation with its ALE interface. In “Listen” mode, the carrier is still passed through to the mixers to allow the reader to detect backscatter and interference generated from other readers. The switched capacitance filters may also be reprogrammed for this “Listen” mode to optimize performance. However in Listen Mode, the reader suppresses its own carrier transmission to negligible levels by switching off the power splitter, setting the amplitude modulation to minimum, and switching off power to the power amplifiers.

In a basic LBT mode, the reader may transmit at full power whenever it detects less than a fixed amount of power (threshold power level) in its “Listen” mode. In its advanced LBT mode, the reader may set threshold power levels for each channel corresponding to its intended transmission channel, ignoring or tolerating more background interference outside of its channel. In the advanced LBT mode, the reader's threshold power levels may also vary with time to avoid situations where a reader fails to ever “talk” at all. In a typical advanced LBT scenario, the reader threshold power level will initially be about −90 dbm for all channels, then about 500 ms later it will be raised to −84 dbm for all channels, then 500 ms later it will be raised again to about −78 dbm for all channels, then about −72 dbm, then about −66 dbm, then about −60 dbm, then about −90 dbm for its own channel plus about −54 dbm for all other channels, then about −84 dbm for its own channel plus about −54 dbm for all channels, etc. In its advanced LBT mode the reader will also never jump immediately from “listen” into its full power “talk” but will instead ramp up to full power in stages while inventorying and quieting any tags it finds first before increasing the power level.

Illustrative Reader Operating Protocol

The following protocol is meant to provide an example of operation of the reader, and is in no way meant to limit the inventive concepts described herein.

(a) Initial Conditions:

The reader begins each new tag Select operation with minimum gain (maximum attenuation) to protect amplifiers and mixers from saturation. The other reader states are preset for the country of operation, protocol, backscatter frequency and modulation type, etc. The initial output power level is preset to 40 mW EIRP and the reader will return to this level every time a new Select command is issued. Initially, the reader transmits only a CW carrier signal.

(b) Operating Protocol:

Reader Setup Steps

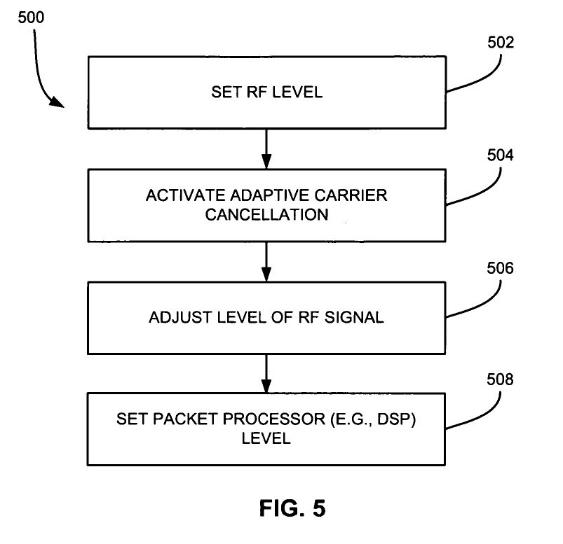

FIG. 5 illustrates a process 500 for setting up the reader according to an illustrative embodiment. Note that while generally the order in which the steps are performed is not always important, the preferred sequence is shown. In operation 502, the RF level is set. RF attenuation is reduced to increase the detected RMS level into its “RF nominal” about 0±6 dbm range. In operation 504, the adaptive carrier cancellation is activated to minimize the RF RMS level. Within 2 ms the adaptive carrier cancellation should reduce the effects of carrier leakage, antenna mismatch, ambient reflection, and associated phase noise associated with the carrier. The RMS level may be reduced by up to 30 db. In operation 506, the RF attenuation is reduced further to ensure that the RMS level remains in its “nominal” 0±6 dbm range; or preferably until the RF attenuation is bypassed entirely. If the interference levels are so high as to prevent the reader from bypassing all of its RF attenuation, the reader will notify the client system which may optionally shut down either this reader or a nearby reader as necessary to reduce this interference. In operation 508, the packet processor (e.g., DSP) level is set. If authorized by the client system, the reader initiates a new Inventory Round by issuing Select and Query Commands to cause any tags in the field of the reader antenna to initiate backscatter. The values of the baseband attenuators are then reduced to raise the DSP input signal level to its “Baseband Nominal” value of about 0.5V±6 db range (for the strongest tags in the field).

Reader Operation Steps

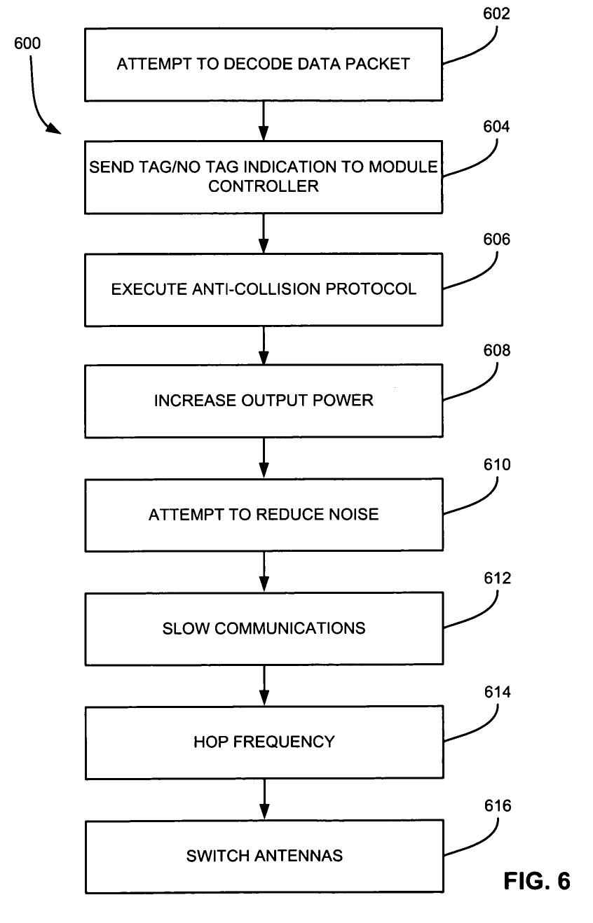

FIG. 6 illustrates a process 600 performed during reader operation according to an illustrative embodiment. Again, while generally the order in which the steps are performed is not always important, the preferred sequence is shown. In operation 602, the DSP tries to decode the data packet. The DSP will, if necessary, repeat this operation up to three times total if permitted by the protocol. If successful, the reader continues with its protocol routine. As the C1G2 anti-collision and inventory progress, the gain of the baseband amplifiers will be increased from time to time (in 6 db steps) to keep the DSP input signal level within its “Baseband Nominal” value, or until such time as the baseband attenuators are bypassed entirely.

Even if the DSP cannot successfully decode the packet, or has inventoried and put to sleep all of the tags within its field, the DSP will at least indicate whether or not it has detected tag backscatter within the expected frequency range and may send a tag/no-tag indication back to the module controller in operation 604.

If the reader detects tag backscatter, but cannot decode the packet successfully, the reader will initially assume that multiple tags have collided and continue executing the normal resolution via the Q anti-collision protocol in operation 606.

If either no backscatter is detected in operation 602, if the anti-collision protocol in operation 606 is unsuccessful, or if all available tags within the session have already been counted and put to sleep, then the reader may attempt various procedures to detect additional tags.

In operation 608 the reader may increase its output power level in steps: first from about 40 mW to about 400 W EIRP, then to about 4 W EIRP or the highest power permitted in that regulatory zone.

The reader may also attempt to reduce noise in operation 610. The middleware may optionally ask the DSP to measure the backscatter frequency, then readjust the centerpoint and narrow the passband of the switched capacitor filter to reduce the noise, and then ask the DSP to try again to decode the data packet. Operation 610 may be repeated several, e.g., three times.

Communications may also be slowed down in operation 612. The middleware may optionally ask the reader to reduce the forward and backscatter rates, re-measure the tag's nominal backscatter frequencies, reset the switched capacitor filter to the narrowest possible filter values, and then try e.g., three more times to decode the data packet.

Preferably, the foregoing operations are completed prior to performing operation 614 or 616. If operations 608, 610 or 612 are still unsuccessful or the field exhausted, the reader may optionally hop frequencies in operation 614. The middleware may optionally ask the reader to hop to a different frequency, bypass operations 602-610, and repeat operation 612. Several different channel frequencies may be tried.

In operation 616, the reader switches antennas. Once the field of the existing antenna has been exhausted per operation 612, before changing sessions or issuing another Select command, the reader will repeat the inventory with each of its antennas starting with operation 504 of the setup procedure of FIG. 5 and continuing through operation 614 of FIG. 6. Several antennas may be present.

Once the field accessible to the current reader has been exhausted, before changing sessions or issuing another Select command, the reader may provide the client system with the option to repeat setup and operation within another reader. The backend system may authorize one of its readers to issue a new Select command or change sessions. The procedures of FIGS. 5 and 6 can then be repeated by the new reader.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A Radio Frequency Identification (RFID) reader, comprising:
an amplifier for amplifying an incoming RF signal;
a switchable filter receiving an amplified signal from the amplifier, the filtering characteristics of the filter being selectable; and
mixers receiving a filtered signal from the filter.

2. An RFID reader as recited in claim 1, wherein the filtering characteristics are selected based on a regional setting of the reader.

3. An RFID reader as recited in claim 1, wherein the filter is selectively disabled.

4. An RFID reader as recited in claim 1, wherein a gain of the amplifier is controllable for preventing saturation of the mixers.

5. An RFID reader as recited in claim 4, further comprising a second amplifier for amplifying an output of one of the mixers, and a third amplifier for amplifying an output of another of the mixers, a gain of the second and third amplifiers being controllable for preventing saturation of a packet processor receiving output therefrom.

6. An RFID reader as recited in claim 1, further comprising switched capacitance filters receiving outputs from the mixers, and a packet processor receiving output from the switched capacitance filters.

7. An RFID reader as recited in claim 1, further comprising a series of filters and amplifiers receiving output from each mixer, each filter in the series being more effective than the previous filter, each filter in the series being noisier than the previous filter.

8. An RFID system, comprising:
a plurality of RFID tags; and
an RFID reader as recited in claim 1 in communication with the RFID tags.

9. A Radio Frequency Identification (RFID) reader, comprising:
an RF section further comprising an RF signal level control; and
a baseband section receiving a signal from the RF section, the baseband section further comprising baseband signal level control, wherein the RF signal level control and the baseband signal level control are dynamically adjustable independently of each other.

10. An RFID reader as recited in claim 9, wherein the RF signal level control comprises at least one of an attenuator and an amplifier.

11. An RFID reader as recited in claim 10, further comprising mixers receiving a signal from the RF signal level control, wherein an input to the mixers is measured, wherein the RF signal level control is instructed to increase or decrease the level of the signal based on the measurement.

12. An RFID reader as recited in claim 9, wherein the baseband signal level control comprises at least one of an attenuator and an amplifier.

13. An RFID reader as recited in claim 12, further comprising a packet processor receiving a signal from the baseband signal level control, wherein the baseband signal level control is instructed to increase or decrease the level of the signal to prevent saturation of the packet processor.

14. An RFID reader as recited in claim 13, wherein the packet processor is a digital signal processor.

15. An RFID reader as recited in claim 9, wherein the baseband signal level control includes a series of amplifiers, wherein a signal frequency at an output of a first amplifier is monitored and used to adjust an upstream frequency filter.

16. An RFID system, comprising:
a plurality of RFID tags; and
an RFID reader as recited in claim 9 in communication with the RFID tags.

17. A Radio Frequency Identification (RFID) reader, comprising:
RF signal level control;
mixers receiving a signal from the RF signal level control;
wherein a level of a signal between the RF signal level control and the mixers is monitored, wherein the RF signal level control is adjusted based on the monitored signal for preventing saturation of the mixers.

18. An RFID reader as recited in claim 17, wherein the RF signal level control comprises at least one of an attenuator and an amplifier.

19. A method for processing a Radio Frequency (RF) signal, comprising:
converting an RF signal to a baseband signal;
amplifying the baseband signal;
filtering the baseband signal;
monitoring the amplified and filtered signal; and
adjusting characteristics of a filter based on the monitoring.

20. A method as recited in claim 19, further comprising attenuating a level of the baseband signal if a level of the baseband signal is above a saturation level of a packet processor.

21. A method as recited in claim 19, wherein the filter is a switched capacitance filter.

22. A method for processing a Radio Frequency (RF) signal, comprising:
converting an RF signal to a baseband signal;
amplifying the baseband signal;
filtering the baseband signal using a filter; and
adjusting characteristics of the filter based on parameters of a communications protocol.

23. A method as recited in claim 22, further comprising attenuating a level of the baseband signal if a level of the baseband signal is above a saturation level of a packet processor.

24. A method as recited in claim 22, wherein the filter is a switched capacitance filter.

25. A method for processing a Radio Frequency (RF) signal, comprising:
setting an RF gain stage to an initial condition;
setting a baseband gain stage to an initial condition;
monitoring a signal having passed through both gain stages; and
adjusting one of the gain stages based on the monitoring.

26. A method as recited in claim 25, further comprising adjusting the gain of both stages based on the monitoring.

27. A method as recited in claim 25, wherein a digital signal processor performs the monitoring.

28. A method as recited in claim 25, further comprising filtering the baseband signal based on a protocol being exercised.

29. A Radio Frequency Identification (RFID) reader, comprising:
an analog amplifier for amplifying an incoming RF signal;
a switched capacitance filter; and
a digital signal processor (DSP).

30. A Radio Frequency Identification (RFID) reader, comprising:
an RF signal level monitoring mechanism; and
a baseband signal level monitoring mechanism.

31. An RFID reader as recited in claim 30, wherein a gain of the baseband signal is adjusted based on monitoring of the baseband signal, wherein a gain of the RF stage is adjusted based on monitoring the RF signal.

32. A Radio Frequency Identification (RFID) reader, comprising:
a switched capacitance filter having different settings during a listen before talk mode than during a tag reading mode.

33. A method, comprising:
turning off a transmitter;
setting filtering parameters of a switched capacitance filter; and
monitoring a power level of an incoming signal.

34. A method, comprising:
adjusting a listen before talk threshold power level as a function of time.

35. A method as recited in claim 34, wherein talk power levels also vary as a function of time.
